(19) United States
(12) Patent Application Publication
(10) Pub. No.: US 2017/0044945 A1
(43) Pub. Date: Feb. 16, 2017

(54) Low Temperature Method and System for Fuel Gas Purification and Utilization Thereof

(71) Applicants: Allan Yubin ZHANG, Eastvale, CA (US); Baoquan ZHANG, Eastvale, CA (US)

(72) Inventors: Allan Yubin ZHANG, Eastvale, CA (US); Baoquan ZHANG, Eastvale, CA (US)

(21) Appl. No.: 15/335,405

(22) Filed: Oct. 26, 2016

(51) Int. Cl. F01N 3/08; B01D 53/79; B01D 53/50; B01D 53/60; B01D 53/92; B01D 53/34

(52) U.S. Cl. CPC F01N 3/0871; B01D 53/92; B01D 53/346; B01D 53/502; B01D 53/60; B01D 53/79; F01N 3/0842; F01N 3/085; B01D 2251/304; B01D 2251/306; B01D 2251/604

(57) ABSTRACT

A low temperature purification system includes a reactor; a lye tank to store oxygen-rich alkaline absorbent; an exhausted gas supplier to provide vehicle exhausted gas to the reactor; a gasification pump arranged between the reactor and the lye tank to spray the oxygen-rich alkaline absorbent to the reactor; wherein the oxygen-rich alkaline absorbent is reacted with vehicle exhausted gas to generate a series of reactions to purify the vehicle exhausted gas. A low temperature purification method includes the following steps: (1) providing vehicle exhausted gas into a reactor; (2) providing oxygen-rich alkaline absorbent into a reactor to form reaction gas; (3) compressing the reaction gas by a piston to generate a series of reactions to generate reacted products; (4) separating liquid-gas-solid in the reacted products to purify the vehicle exhausted gas.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a low temperature purification method and system, and more particularly to a low temperature purification method and system for flue gas and its utilization, wherein the low temperature purification method and system are adapted to be integrated with the present vehicle systems.

Description of Related Arts

Nowadays, the main resource of air pollution is the combustion of fuel gas in vehicle engines. The exhausted gas from vehicle combustion engines contains gaseous nitrogen oxides (NOₓ), sulfur oxides (SOₓ), and carbon dioxide (CO₂). These compounds are the main sources of atmospheric pollutants. Air pollution causes a series of environmental, ecological, and social issues. For instance, emissions of SOₓ and NOₓ increase rain acidity which has serious affects on our environment and millions of lives. NOₓ causes photochemical smog pollutions, and CO₂ is recognized as the primary pollution gas that causes the greenhouse effect.

There are more and more people who have vehicles, so more and more atmospheric pollution are emitted to our atmosphere. Thus, a way of solving this problem has become an urgent task.

Currently, the primary method is to purify exhausted gas is by a way of ternary catalysts, which are mainly platinum, rhodium, and palladium. Rhodium is used to generate N₂ due to its high catalytic activity and selectivity. Platinum and palladium, both effective metal catalysts, are used to purify carbon monoxide (CO) and hydrocarbons (HC). For ternary catalytic fuel gas purification, air-fuel ratio has a large effect on purification characteristics. When the air-fuel ratio is greater than 14.6, which is known as an oxygen-rich condition, there is a high efficiency on CO and HC purification. When this air-fuel ratio is less than 14.6, which is known as a fuel-rich condition, there is a high efficiency on NOₓ purification. In order to maintain a high efficiency for purifying all three types of pollutants, the air-fuel ratio is generally kept within 14.6±0.1 for this ternary catalytic method.

According to the above mentioned ternary catalytic fuel gas purification, the efficiency for purifying HC and CO is better than that of purifying NOₓ. Therefore, if the method of the present invention is adapted to combine with the existing ternary catalytic method, the ability to control atmospheric pollution will be strengthened.

However, the above mentioned method has several drawbacks. Platinum has low activity for the conversion of NOx and its price is relative higher than palladium. In addition, platinum is sensitive to the high temperatures which may occur in the catalytic converter during high engine loads. Palladium has very good activity for the removal of NOx, but palladium includes its sensitivity to pollutions from exhausted gas. Rhodium also has the highest activity for the removal of the NOx, but rhodium is a very expensive metal. Furthermore, no matter platinum, palladium, and rhodium are both precious metals, so it is highly to make effort to find cheaper and casual metals for replacing the above mentioned three metals.

### SUMMARY OF THE PRESENT INVENTION

The invention is advantageous in that it provides a low temperature purification method and system for efficiently purifying vehicle exhausted gas without using a costly metal as catalyst, and producing any secondary pollution.

Another advantage of the invention is to provide a low temperature purification method and system, wherein the low temperature purification method and system do not require any external source of energy, so as to provide the most energy saving properties for the purification.

Another advantage of the invention is to provide a low temperature purification method and system, wherein the oxygen-rich alkaline liquid absorbent mainly comprises NaOH and KOH in aqueous solution, and these two compounds are cheap and abundant, which minimizes the cost of this process.

Another advantage of the invention is to provide a low temperature purification method and system, wherein the low temperature purification system is a simple construction on a small scale, with a relatively small footprint along with minimal cost and minimal setting expense.

Another advantage of the invention is to provide a low temperature purification method and system, wherein the low temperature purification method and system provide a clear view for simultaneous desulfurization and denitration of exhaust gas, which will improve purification efficiency.

Another advantage of the invention is to provide a low temperature purification method and system which can be widely applied to the purification of various acidic gases in both internal combustion engines and generator.

Another advantage of the invention is to provide a low temperature purification method and system which is a pneumatic-hydraulic approach to fuel gas purification without the use of a costly metal as catalyst, and does not produce any secondary pollution.

Additional advantages and features of the invention will become apparent from the description which follows, and may be realized by means of the instrumentalities and combinations particular point out in the appended claims.

According to the present invention, the foregoing and other objects and advantages are attained by a low temperature purification system, comprising:

a reactor;

a lye tank to store oxygen-rich alkaline absorbent;

an exhausted gas supplier to provide vehicle exhausted gas to the reactor;

a gasification pump arranged between the reactor and the lye tank to spray the oxygen-rich alkaline absorbent to the reactor; wherein

the oxygen-rich alkaline absorbent is reacted with vehicle exhausted gas to generate a series of reactions to purify the vehicle exhausted gas.

In accordance with another aspect of the invention, the present invention comprises a low temperature purification method, comprising the following steps:

(1) provide vehicle exhausted gas into a reactor;

(2) provide oxygen-rich alkaline absorbent into a reactor to form reaction gas;

(3) compress the reaction gas by a piston to generate a series of reactions to generate reacted products;

(4) separate liquid-gas-solid in the reacted products to purify the vehicle exhausted gas.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a low temperature purification system according to a first preferred embodiment of the present invention.

FIG. 2 is a block diagram of a low temperature purification method according to a second preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

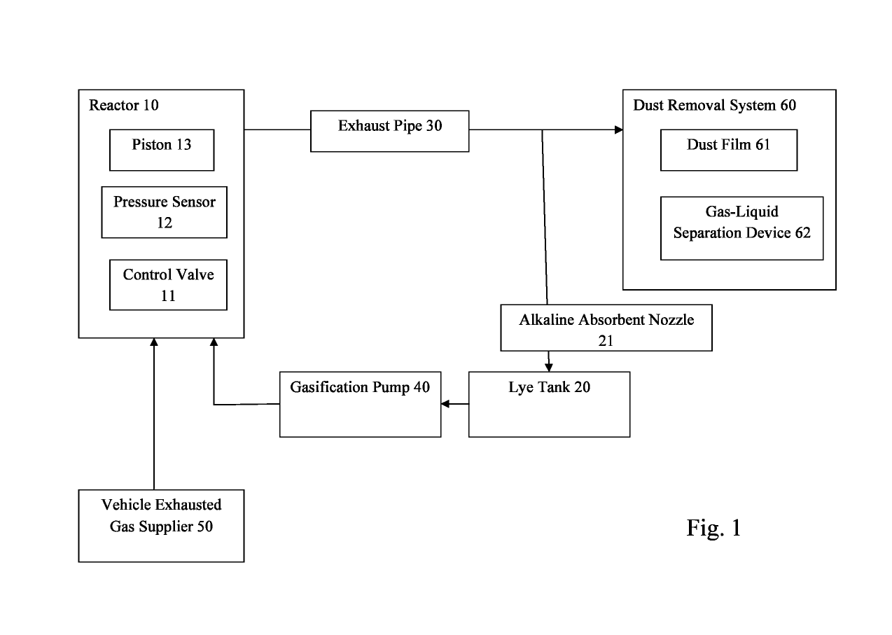

Referring to FIG. 1 of the drawings, a low temperature purification system according to a first preferred embodiment of the present invention is illustrated, wherein the system comprises a reactor 10, a lye tank 20, and a gasification pump 40 arranged between the reactor 10 and the lye tank 20 to provide oxygen-rich alkaline absorbent to the reactor 10. The reactor 10 is served as a pollution purification reactor. Preferably, the reactor 10 is a cylinder.

Accordingly, the pollution of the present invention is embodied as the vehicle exhausted gas. Therefore, the system further comprises a vehicle exhausted gas supplier 50 connected with the reactor 10, wherein the vehicle exhausted gas supplier 50 is able to provide exhausted gas to the reactor 10, and the exhausted gas can diffuse inside the reactor 10 and is reacted with the alkaline absorbent. Generally, the exhausted gas, also known as fuel gas, is emitted as a result of the combustion of fuel. The major pollutants of the vehicle exhausted gas are: carbon monoxide (CO), hydrocarbons, (HC), nitrogen oxides (NO_{X}), particulate matter (PM), carbon dioxide (CO₂), sulfur dioxide (SO₂), and etc.

The oxygen-rich alkaline absorbent is stored inside the lye tank, wherein the oxygen-rich alkaline absorbent mainly comprises NaOH and KOH, and other alkaline solutions, and the oxygen-rich alkaline liquid absorbent is made by dissolving sodium hydroxide and potassium hydroxide in water, in a ratio of 1:100 and the weight ratio of alkaline:water is 0:100-350:100. The oxygen-rich alkaline absorbent is transported to the gasification pump 40 to spray and diffuse the oxygen-rich alkaline absorbent into the reactor 10, and then the oxygen-rich alkaline absorbent is reacted with the pollutions of the exhausted gas, such as nitrogen oxides (NOₓ) and sulfur dioxide (SO₂).

And, the reactor 10 comprises a piston 13 to compress the reaction gas inside the reactor 10 to decrease the volume of the reaction gas inside the rector 10 and naturally increase the pressure of the reaction gas. According to the present invention, the reaction gas comprises the pollutions of the exhausted gas and gaseous oxygen-rich alkaline absorbent. In such a manner, the water vapor in the exhausted gas is reacted with the pollutants of the exhausted gas. For example, the gaseous nitrogen oxides (NOₓ) and sulfur dioxide (SO₂) are reacted with the water vapor to form H₂SOₓ and HNO₃. These acids are reacted with an acid-base reaction with the oxygen-rich alkaline absorbent to form salt group, such as Na₂SO₄, NaNO₃, K₂SO₄, KNO₃, etc.

Accordingly, the system further comprises a pressure sensor 12 attached to the reactor 10 to monitor the internal pressure changes inside the reactor 10, an exhaust pipe 30 connected with the reactor 10, a control valve 11 to control the pressure changes inside the reactor 10, an alkaline absorbent nozzle 21 connected with the exhaust pipe 30 and the lye tank 20 to control the remaining alkaline absorbent for transporting back into the lye tank 20 for the next reaction cycle, and a dust removal system 60 connected with control valve 11 by the exhausted pipe 30. In addition, the dust removal system 60 comprises a dust film 61 and a gas-liquid separation device 62, wherein the dust film 61 is adapted to remove and collect dust and other solid-state products from the reaction gas produced in the reactor 10, and the gas-liquid separation device 62 is adapted to separate the gas and liquid, and then the purified gas is expelled to the atmosphere. For example, after the reaction in the reactor 10, the dust removal system 60 is adapted to collect the sulfates and nitrates produced after the reaction inside the reactor 10, so as to prevent SOₓ and NOₓ from entering the atmosphere, and achieving the goal of purification.

During the compression of the piston 13 for the reaction inside the reactor 10, the piston 13 move upwardly to compress the reaction gas and push the reaction gas out of the reactor 10 to the exhaust pipe 30. In the reaction inside the reactor 10, the oxygen-rich alkaline liquid absorbent is sprayed into the reactor 10 from the lye tank 20 by way of the gasification pump 40. When the reaction gas is compressed along oxygen-rich alkaline liquid absorbent, gaseous SO₂ and NOₓ are reacted with O₂ and the oxygen-rich alkaline liquid absorbent to produce stable sulfates and nitrates by increasing the pressure in the reactor 10 and decreasing the volume thereof, and then forming sulfates and nitrates in the alkaline solution. Then, sulfates and nitrates are separated from aqueous solution to purify the exhausted gas. When the pressure in the reactor 10 is at a specific level, the control valve 11 is opened and the reaction gases are expelled through the exhaust pipe 30 to decrease the pressure in the reactor 10. And, the remaining oxygen-rich alkaline absorbent is returned back to the lye tank 20 and is used for the next reaction cycle. Then by separation of the gases and liquids, the purified exhausted gas is expelled.

It is worth to mention that the major pollutants in the exhausted gas are nitrogen dioxide (NO₂) and sulfur dioxide (SO₂), and the chemical reactions between the pollutants and the alkaline absorbent are described as follows.

Nitrogen oxides (NO₂) are purified through a series of denitration reactions. In the reactor 10, nitric oxide (NO) is oxidized to form nitrogen dioxide (NO₂), as shown in formula (a). When the reaction gas is compressed, the NO₂ dissolves in water, as shown in formula (b). A disproportionation reaction then occurs, forming nitric acid (HNO₃) and nitrous acid (HONO), as shown in formula (c1) and (c2). Then HNO₃ and HONO is neutralized by the NaOH and/or KOH in the alkaline absorbent, forming sodium nitrate (NaNO₃), sodium nitrite (NaNO₂), or, potassium nitrate (KNO₃), and potassium nitrite (KNO₂), as shown in formula (d1) and (d2). Through the above mentioned reactions, gaseous nitrogen oxides (NO₂) turn into nitrate and nitrite in solution. The above mentioned reactions are listed as following formula:

2NO+O₂→2NO₂ (a)

2NO₂+H₂O→HNO₃+HNO₂ (b)

HNO₃+NaOH→NaNO₃+H₂O (c1)

HNO₂+NaOH—NaNO₂+H₂Oc (c2)

HNO₃+KOH→KNO₃+H₂O (d1)

HNO₂+KOH→KNO₂+H₂O (d2)

Sulfur dioxide (SO₂) is purified through a series of redox and acid-base neutralization reactions. Sulfur dioxide (SO₂) is oxidized to form sulfur trioxide (SO₃), as shown in formula (e). Sulfur trioxide then dissolves in water to form sulfuric acid (H₂SO₄), as shown in formula (f). The sulfuric acid is then neutralized by the NaOH and/or KOH from the alkaline absorbent, producing sodium sulfate (Na2SO4) and/or potassium sulfate (K₂SO₄), as shown in formula (g1) and (g2). The above mentioned reactions are listed as following formula:

SO₂+O₂→SO₃ (e)

SO₃+H₂O→H₂SO₄ (f)

H₂SO₄+2NaOH→Na₂SO₄+H₂O (g1)

H₂SO₄+2KOH→K₂SO₄+H₂O (g2)

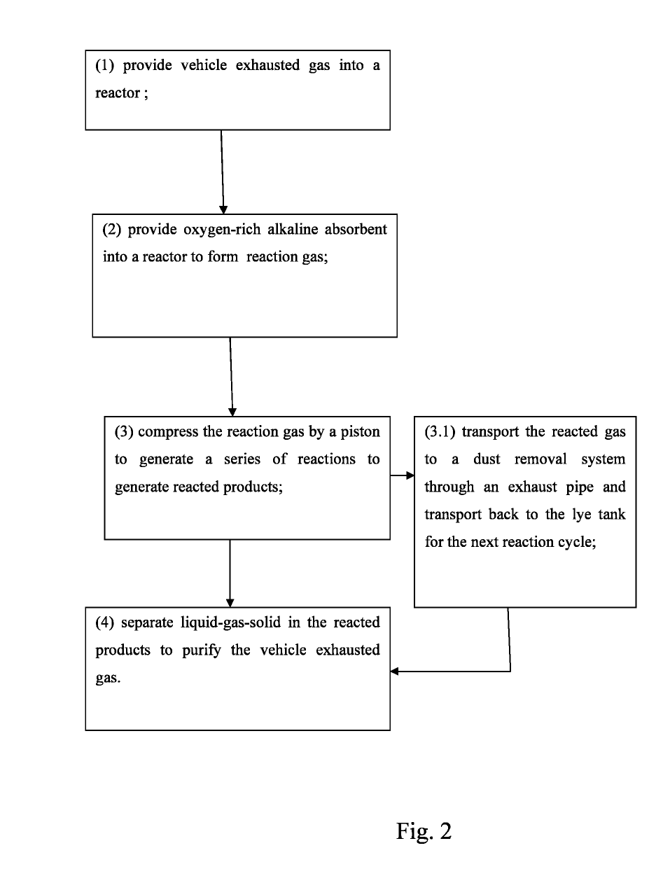

Referring to FIG. 2 of the drawings, a low temperature purification method according to a second preferred embodiment of the present invention is illustrated, wherein the low temperature purification method comprises the following steps:

(1) provide vehicle exhausted gas into a reactor 10;

(2) provide oxygen-rich alkaline absorbent into a reactor 10 to form reaction gas;

(3) compress the reaction gas by a piston 13 to generate a series of reactions to generate reacted products;

(4) separate liquid-gas-solid in the reacted products to purify the vehicle exhausted gas.

In the step (1), the major pollutants of the vehicle exhausted gas are: carbon monoxide (CO), hydrocarbons, (HC), nitrogen oxides (NOₓ), particulate matter (PM), carbon dioxide (CO₂), sulfur dioxide (SO₂), and etc.

In the step (2), the oxygen-rich alkaline absorbent is stored inside a lye tank 20, wherein the oxygen-rich alkaline absorbent comprises NaOH and/or KOH, and other alkaline solutions, and the oxygen-rich alkaline liquid absorbent is made by dissolving sodium hydroxide and potassium hydroxide in water, in a ratio of 1:100 and the weight ratio of alkaline:water is 0:100 to 350:100.

In the step (2), the oxygen-rich alkaline absorbent is transported to a gasification pump to spray and diffuse the oxygen-rich alkaline absorbent into the reactor 10, and then the oxygen-rich alkaline absorbent is reacted with the pollutions of the exhausted gas, such as nitrogen oxides (NOₓ) and sulfur dioxide (SO₂).

In the step (3), during the compression of the piston 13 for the reaction inside the reactor 10, the piston 13 move upwardly to compress the reaction gas, and the reaction gas is compressed along oxygen-rich alkaline liquid absorbent, gaseous SO₂ and NOₓ are reacted with O₂ and the oxygen-rich alkaline liquid absorbent to produce stable sulfates and nitrates by increasing the pressure in the reactor 10 and decreasing the volume thereof, and then forming sulfates and nitrates in the reacted product.

The low temperature purification method further comprises a step (3.1): transport the reacted gas to a dust removal system 60 through an exhaust pipe 30 and transport back to the lye tank 20 for the next reaction cycle,

In the step (4), sulfates and nitrates are separated from the reacted product through the dust removal system 60 to purify the exhausted gas.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A low temperature purification system, comprising:
a reactor;
a lye tank to store oxygen-rich alkaline absorbent;
an exhausted gas supplier to provide exhausted gas to said reactor; and
a gasification pump arranged between said reactor and said lye tank to spray said oxygen-rich alkaline absorbent to said reactor, wherein said oxygen-rich alkaline absorbent is reacted with said exhausted gas to generate a series of reactions to purify said vehicle exhausted gas.

2. The low temperature system, as recited in claim 1, wherein said reactor is a cylinder.

3. The low temperature purification system, as recited in claim 1, wherein said exhausted gas includes pollutants selected from a group consisting of carbon monoxide (CO), hydrocarbons, (HC), nitrogen oxides (NOₓ), particulate matter (PM), carbon dioxide (CO₂), and sulfur dioxide (SO₂).

4. The low temperature purification system, as recited in claim 3, wherein said oxygen-rich alkaline absorbent comprises NaOH, and other alkaline solutions, and said oxygen-rich alkaline liquid absorbent is made by dissolving sodium hydroxide and potassium hydroxide in water, in a ratio of 1:100.

5. The low temperature purification system, as recited in claim 3, wherein said oxygen-rich alkaline absorbent comprises KOH, and other alkaline solutions, and said oxygen-rich alkaline liquid absorbent is made by dissolving sodium hydroxide and potassium hydroxide in water, in a weight ratio of alkaline:water of 0:100 to 350:100.

6. The low temperature purification system, as recited in claim 4, wherein said reactor comprises a piston to compress said reaction gas inside said reactor to decrease the volume of said reaction gas inside said rector and naturally increase the pressure inside said reactor.

7. The low temperature purification system, as recited in claim 6, wherein water vapor in said exhausted gas is reacted with said nitrogen oxides (NOₓ) and sulfur dioxide (SO₂) to form H₂SOₓ and HNO₃, which are reacted with an acid-base reaction with an alkaline absorbent to form a salt selected from a group consisting of NaNO₃, K₂SO₄ and KNO₃.

8. The low temperature purification system, as recited in claim 7, wherein in the reaction inside said reactor, the oxygen-rich alkaline liquid absorbent is sprayed into said reactor, wherein said reaction gas is compressed along oxygen-rich alkaline liquid absorbent by said piston, and gaseous SO₂ and NOₓ are reacted with O₂ and the oxygen-rich alkaline liquid absorbent to produce stable sulfates and nitrates, and then forming sulfates and nitrates in the alkaline solution.

9. The low temperature purification system, as recited in claim 8, further comprising a pressure sensor attached to said reactor to monitor the internal pressure changes inside said reactor, an exhaust pipe connected with said reactor, and a control valve to control the pressure changes inside said reactor.

10. The low temperature purification system, as recited in claim 9, wherein when the pressure in said reactor is at a specific level, said control valve is opened and said reaction gases are expelled through said exhaust pipe to decrease the pressure in said reactor.

11. The low temperature purification system, as recited in claim 8, further comprising an alkaline absorbent nozzle connected with said exhaust pipe and said lye tank to control remaining oxygen-rich alkaline absorbent for transporting back into said lye tank for the next reaction cycle.

12. The low temperature purification system, as recited in claim 8, further comprising a dust removal system connected with said control valve by said exhausted pipe, wherein said dust removal system comprises a dust film to remove and collect dust and other solid-state products from the reaction gas produced in said reactor and a gas-liquid separation device to separate the gas and liquid.

13. The low temperature purification system, as recited in claim 8, wherein after the reaction in said reactor, the dust removal system is adapted to collect the sulfates and nitrates

14. A low temperature purification method for purifying vehicle exhausted gas, comprising comprises the steps of:
(a) providing said vehicle exhausted gas into a reactor;
(b) providing oxygen-rich alkaline absorbent into said reactor to form reaction gas;
(c) compressing the reaction gas by a piston to generate a series of reactions to generate reacted products; and
(d) separating liquid-gas-solid in the reacted products to purify said vehicle exhausted gas.

15. The low temperature purification method, as recited in claim 14, wherein, in the step (a), said vehicle exhausted gas includes pollutants selected from a group consisting of carbon monoxide (CO), hydrocarbons, (HC), nitrogen oxides (NOₓ), particulate matter (PM), carbon dioxide (CO₂), and sulfur dioxide (SO₂).

16. The low temperature purification method, as recited in claim 15, wherein in said step (b), said oxygen-rich alkaline absorbent is stored inside a lye tank, wherein said oxygen-rich alkaline absorbent is comprises NaOH, and other alkaline solutions, and is made by dissolving sodium hydroxide and potassium hydroxide in water, in a ratio of 1:100 and a weight ratio of alkaline:water is 0:100 to 350:100.

17. The low temperature purification method, as recited in claim 15, wherein in said step (b), said oxygen-rich alkaline absorbent is stored inside a lye tank, wherein said oxygen-rich alkaline absorbent is comprises KOH, and other alkaline solutions, and is made by dissolving sodium hydroxide and potassium hydroxide in water, in a ratio of 1:100 and a weight ratio of alkaline:water is 0:100 to 350:100.

18. The low temperature purification method, as recited in claim 15, wherein in said step (b), said oxygen-rich alkaline absorbent is stored inside a lye tank, wherein said oxygen-rich alkaline absorbent is comprises NaOH and KOH, and other alkaline solutions, and is made by dissolving sodium hydroxide and potassium hydroxide in water, in a ratio of 1:100 and the weight ratio of alkaline:water is 0:100 to 350:100.

19. The low temperature purification method, as recited in claim 18, wherein in said step (b), said oxygen-rich alkaline absorbent is transported to a gasification pump to spray and diffuse said oxygen-rich alkaline absorbent into said reactor, and then said oxygen-rich alkaline absorbent is reacted with nitrogen oxides (NOₓ) and sulfur dioxide (SO₂).

20. The low temperature purification method, as recited in claim 18, wherein in said step (c), said piston moves upwardly to compress said reaction gas, and said reaction gas is compressed along said oxygen-rich alkaline liquid absorbent, and SO₂ and NOₓ are reacted with O₂ and said oxygen-rich alkaline liquid absorbent to produce stable sulfates and nitrates by increasing the pressure in said reactor and decreasing the volume thereof, and then forming sulfates and nitrates in said reacted product.

21. The low temperature purification method, as recited in claim 15, after the step (c), further comprising a step (c.1) of transporting said reacted gas to a dust removal system through an exhaust pipe and transport back to the lye tank for the next reaction cycle,

22. The low temperature purification method, as recited in claim 20, wherein in said step (d), said sulfates and said nitrates are separated from said reacted product through said dust removal system to purify the exhausted gas.
